(19) United States
(12) Patent Application Publication
(10) Pub. No.: US 2023/0388118 A1
(43) Pub. Date: Nov. 30, 2023

(54) ENHANCED DUAL LAYER ENCRYPTION FOR CARRIER NETWORKS

(71) Applicant: CenturyLink Intellectual Property LLC, Broomfield, CO (US)

(72) Inventors: Philip FAGAN, Denver, CO (US); Christopher MILLER, Broomfield, CO (US); Douglas HAZELGROVE, Centreville, VA (US)

(73) Assignee: CenturyLink Intellectual Property LLC, Broomfield, CO (US)

(21) Appl. No.: 18/158,435

(22) Filed: Jan. 23, 2023

Related U.S. Application Data
(60) Provisional application No. 63/365,316, filed on May 25, 2022.

(51) Int. Cl. H04L 9/32

(52) U.S. Cl. CPC H04L 9/32

(57) ABSTRACT

This disclosure describes systems, methods, and devices related to a carrier network performing multi-layer encryption of data. A multi-layer encryption method may include generating, by a first network interface device of a carrier network, a first medium access control (MAC) layer encryption of data; sending, by the first network interface device to a second network interface device of the carrier network, the first MAC layer encryption of data; generating, by the second network interface device of a carrier network, a second MAC layer encryption of data comprising the first MAC layer encryption of data; and sending, by the second network interface device, the second MAC layer encryption of data.

### CROSS-REFERENCE TO RELATED PATENT APPLICATION(S)

This application claims the benefit of U.S. Provisional Application No. 63/365,316, filed May 25, 2022, the disclosure of which is incorporated by reference as set forth in full.

### TECHNICAL FIELD

Embodiments of the present invention generally relate to systems and methods for multiple layers of data encryption performed by carrier networks.

### BACKGROUND

People are increasingly interested in protecting sensitive information. Implementing data security techniques in computer systems that send, receive, and process data may be challenging, particularly when existing computer network architecture may be required to meet new data security requirements. Often, existing computer networks must add or change hardware to satisfy new data security requirements, such as multi-layer encryption.

### SUMMARY

A carrier network may include multiple devices, such as switching devices and virtual private network (VPNs) gateways, and may provide multiple VPNs. The carrier network may perform multiple layers of data encryption by generating, by a first network interface device of the carrier network, a first medium access control (MAC) layer encryption of data. The carrier network may send, using the first network interface device, to a second network interface device of the carrier network, the first MAC layer encryption of data. The carrier network may generate, using the second network interface device of a carrier network, a second MAC layer encryption of data including the first MAC layer encryption of data. The carrier network may send, using the second network interface device, the second MAC layer encryption of data to another device of the carrier network, such as a VPN gateway device.

The first network interface device of the carrier network may be a first switch device, and the second network interface device may be a second switch device.

Of the multiple layers of encryption performed by the carrier network, the first MAC layer encryption of data and the second MAC layer encryption of data may use a MAC security (MACsec) protocol, and the data being encrypted may be Internet Protocol (IP) data.

The carrier network may provide multiple VPNs. A first VPN of the carrier network may include the first network interface device and the second network interface device. The second MAC layer encryption of data may be sent to a first gateway device of the first VPN, which may decrypt the second MAC layer encryption of data, but not the first MAC layer encryption of the data.

The carrier network may send, using the first gateway device, the decrypted MAC layer encryption of data to a second gateway device of a second VPN of the carrier network. The second gateway device may decrypt the first MAC layer encryption of data.

### BRIEF DESCRIPTION OF THE DRAWINGS

FIG. 1 illustrates an exemplary carrier network environment in accordance with one embodiment.

FIG. 2 is an exemplary architecture for a carrier network environment in accordance with one embodiment.

FIG. 3 illustrates an exemplary frame encrypted using multi-layer encryption in accordance with one embodiment.

FIG. 4 is a flowchart illustrating a process for multi-layer encryption in accordance with one embodiment.

FIG. 5 is a diagram illustrating an example of a computing system that may be used in implementing embodiments of the present disclosure.

### DETAILED DESCRIPTION

Aspects of the present disclosure involve systems, methods, and the like, for performing multiple layers of data encryption using carrier networks.

To protect sensitive data transmitted using computer networks, some data security requirements may include multi-layer encryption. For example, data may be required to be encrypted multiple times, such as encrypted data being encrypted a second or third time, requiring decryption of each layer of encryption applied.

To apply multi-layer encryption techniques, some existing computer network systems may need to add or change hardware. For example, to apply multiple layers of medium access control (MAC)-layer encryption (e.g., the MAC layer—the link layer/layer 2—of the Open Systems Interconnection model's communication stack), some computer network systems using local area network (LAN) Ethernet switches may require new hardware. In particular, Ethernet and some other switches may encrypt at a different layer than the MAC layer (e.g., layer-3 encryptions, such as using the IP Security protocol), and therefore may not be able to perform multi-layer encryption at the MAC layer (e.g., MACsec— MAC Security protocol—applied at multiple layers as MACsec over MACsec, MACsec over MACsec over MACsec, etc.). An existing network system with Ethernet switches, for example, may need to add multiple switches with MAC-layer encryption capability to satisfy multi-layer MAC encryption requirements. In particular, Internet carriers (e.g., service providers) currently do not implement multi-layer MAC encryption within the carrier networks, as multi-layer MAC encryption does not require Internet Protocol (IP) addresses, whereas layer-3 encryption such as IPsec requires IP addresses and operates on IP packets instead of layer-2 frames. IPSec, for example, may not secure all dynamic host configuration protocol (DHCP) traffic or all address resolution protocol (ARP) traffic, whereas MAC Sec may secure all DHCP and ARP traffic. Secure sockets layer (SSL) and transport layer security (TLS) are additional examples that operate on another layer higher than layer-2, and may require application layer changes. Optical encryption occurs at the physical layer (PHY) may encrypt more data than layer-2 encryption (e.g., a preamble, a cyclic redundancy check or frame check sequence, and an inter frame gap, for example).

There is therefore a need for multi-layer MAC encryption of data within Internet carrier networks.

In one or more embodiments, multi-layer MAC encryption of data within Internet carrier networks may include dual encryption (e.g., one encryption of data, and another encryption of the encrypted data). For example, dual MAC-layer encryption may include MACsec over MACsec encryption, in which data are encrypted using a MACsec protocol (e.g., an inner-layer layer encryption), and that encrypted data are encrypted again using a MACsec protocol (e.g., an outer-layer encryption). In this manner, the decryption may include decrypting the outer MAC-layer encryption, and then decrypting the inner MAC-layer encryption.

In one or more embodiments, multi-layer MAC encryption of data within Internet carrier networks may be performed by IP carrier network interface devices (NIDs), such as switches, routers, and other network devices (e.g., capable of implementing the techniques described in IEEE 802.1ae). For example, an inner-layer MAC encryption may include two MACsec-enabled switches using a private line between them to communicate data within an Internet carrier network. The MACsec-enabled switches each may be able to perform an inner layer MAC encryption, and may send the MAC-layer encrypted data to another MACsec-enabled switch, which may be behind a firewall. To add a second layer of MAC-level encryption (e.g., an outer layer of encryption), the carrier network may include a second set of MACsec-enabled switches—one switch for each of the inner-layer MACsec-enabled switches—capable of performing a second MAC-layer encryption of the inner-layer encrypted data. In this manner, the data transmitted between MACsec-enabled switches using a private line within the carrier network may be encrypted twice—an inner layer and an outer layer—using MAC-layer encryptions, prior to being transmitted outside of a virtual private network (VPN). In particular, the inner and outer layers of the Internet carrier network may use optical wave service and/or carrier wave service. The NIDs are not limited to switches and routers, however. Other MACsec-enabled network devices may perform the multi-layer encryption. In some examples, virtual network functions may be deployed on carrier network nodes, such as edge nodes, to implement 802.1ae and create a MACsec-enabled mesh over a network regardless of device type (e.g., microwave radio point-to-point, optical lasers, electrical, etc.).

In one or more embodiments, the data plane of the carrier network may use MACsec-enabled devices for both the inner and outer layer encryptions. IP traffic may be avoided by using the inner and outer VPN layers with dual-layer MAC encryption. One layer of traffic may be protected by the outer-layer MAC encryption, and another layer of traffic may be protected by the inner-layer MAC encryption.

In one or more embodiments, the management plane of the carrier network may reside on one or more server modules, which may slot into each of the inner-layer MAC encryption components and the outer-layer MAC encryption components. The server modules for the enclaves may be built with a hypervisor, for example, and may provide underlying resource services for virtualized management plane components. The management plane components may include a virtual firewall at remote sites for VPN termination, and a server to act as a jump host. The carrier system may leverage one-way passive optical taps for “low-to-high” aggregation of raw network traffic (e.g., for inspection purposes).

The above descriptions are for purposes of illustration and are not meant to be limiting. Numerous other examples, configurations, processes, etc., may exist, some of which are described in greater detail below. Example embodiments will now be described with reference to the accompanying figures.

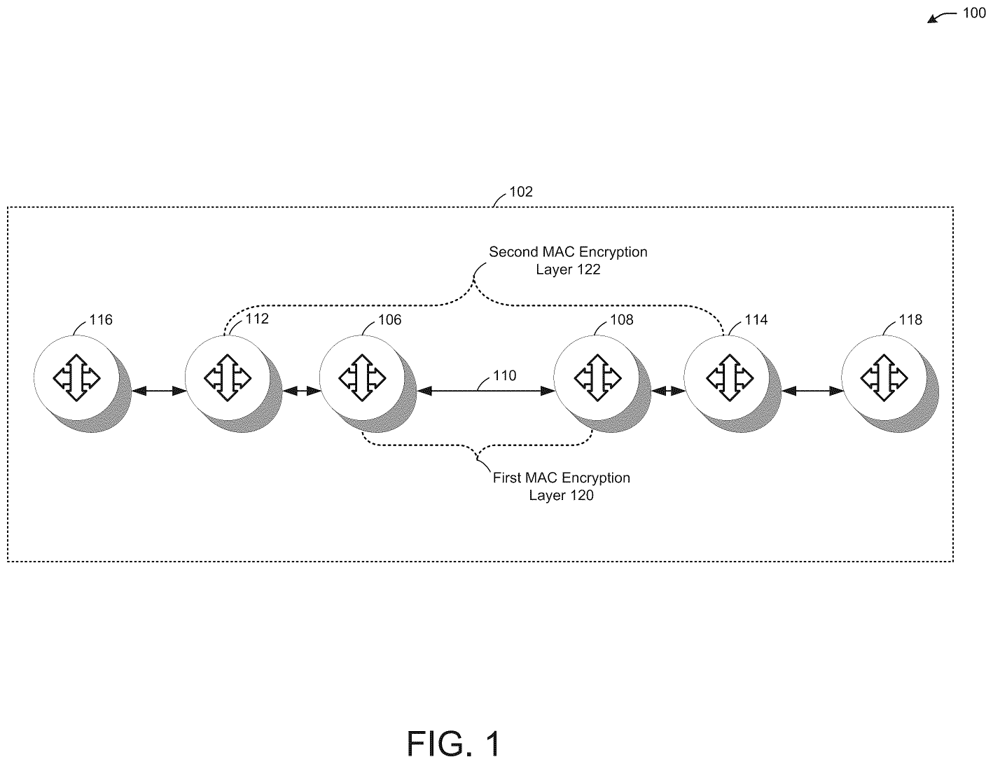

FIG. 1 illustrates an exemplary carrier network environment 100 in accordance with one embodiment.

Referring to FIG. 1, the carrier network environment 100 may include multiple virtual private networks (VPNs) 102 facilitated by multiple network interface devices (NIDs), such as NID 106 and NID 108, which may connect via a private line (e.g., using optical wave and/or carrier wave service). The carrier network environment 100 also may include NID 112, NID 114, NID 116, and NID 118, along with other NIDs not shown. The NID 106 and the NID 108 may encrypt data using a link layer encryption protocol (e.g., MAC Sec or another MAC-layer protocol), providing a first MAC encryption layer 120.

Still referring to FIG. 1, to add another layer of encryption, the MD 112 and the NID 114 may be included in the carrier network environment 100. For example, the NID 106 may encrypt data, and the NID 112 also may encrypt the data, providing a second MAC encryption layer 122 (e.g., a second encryption of encrypted data). Similarly, the NID 108 may encrypt data, and the NID 114 also may encrypt the data, providing the second MAC encryption layer 122. In this manner, two layers of encryption may be provided by the carrier network environment 100.

In one or more embodiments, the multi-layer encryption provided by the carrier network environment 100 may occur at the link layer, using a MACSec protocol or another MAC-layer encryption technique. Because Ethernet and some other switches different than the NIDs of FIG. 1 may encrypt at a different layer than the link layer, the multi-layer encryption provided by the NIDs of FIG. 1—enabled for MAC-layer encryption—may avoid the need for IP addresses, unlike layer-3 encryption devices used in some Internet carrier network environments.

In one or more embodiments, the NIDs of the carrier network environment 100 may include MACSec-enabled switches and routers, such as CIENA switches and routers, Cisco switches and routers, or other types and brands of network devices (e.g., not limited to switches and routers). For example, the NIDs may include any devices capable of performing MACsec-enabled multi-layer encryption, such as devices capable of implementing 802.1ae techniques.

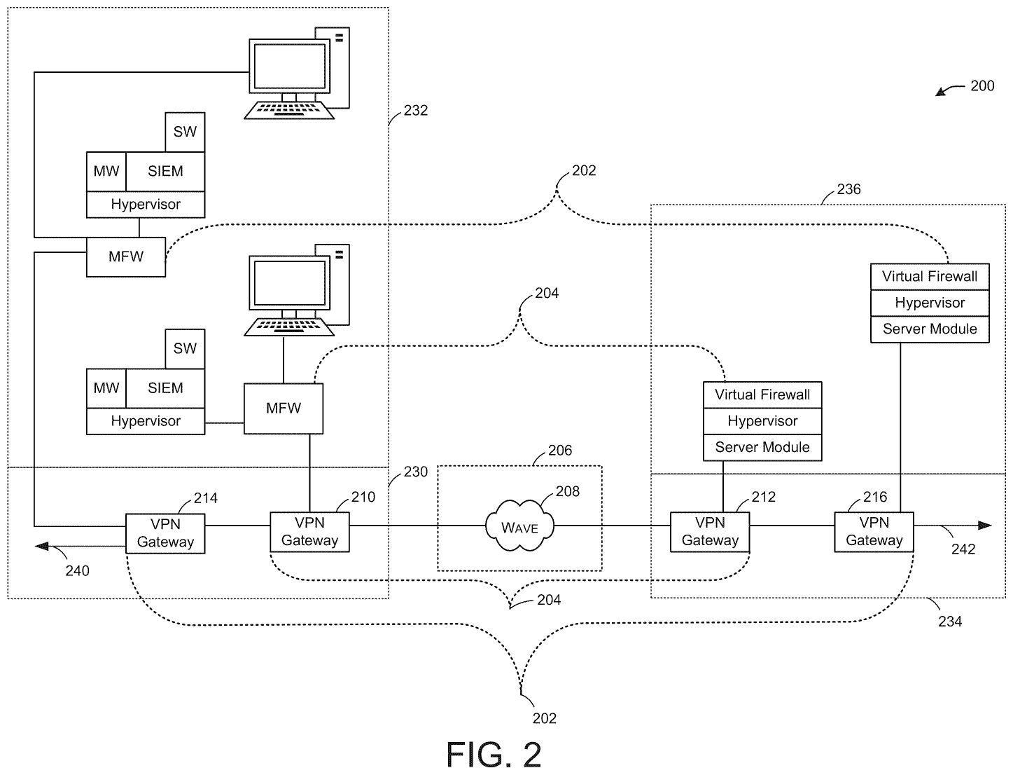

FIG. 2 is an exemplary architecture 200 for a carrier network environment (e.g., the carrier network environment 100 of FIG. 1) in accordance with one embodiment.

Referring to FIG. 2, the architecture 200 may provide multiple VPNs (e.g., an inner VPN 202 and an outer VPN 204) facilitated by VPN gateways. For example, a network 206 may use optical wave service and/or carrier wave service to provide the outer VPN 204 by using a VPN gateway 210 and a VPN gateway 212. A VPN gateway 214 and a VPN gateway 216 may provide the inner VPN 202. The VPN gateways may be part of respective data planes for two different geographic locations (e.g., a data plane 230 corresponding to a management plane 232 at a first location, and a data plan 234 corresponding to a management plane 236 at a second location). The VPN gateway 214 may hand off 240 data that has been encrypted by the inner VPN 202, and the VPN gateway 216 may hand off 242 data that has been encrypted by the inner VPN 202. The inner VPN 202 may provide a first layer of encryption at the link layer, and the outer VPN 204 may provide a second layer of encryption at the link layer. The multiple layers of encryption may use a MACSec protocol or other MAC-layer encryption.

Still referring to FIG. 2, the management planes of the architecture 200 may use an IP Security protocol (e.g., IPSec) for the respective VPNs (e.g., a management layer IPSec using the inner VPN 202 and a management layer IPSec using the outer VPN 204). The management planes may include server modules, hypervisors, virtual firewalls, middle ware (MW), software (SW), security information and event management (STEM), and the like. Each VPN may use its own components in the management planes at respective locations as shown.

In one or more embodiments, the architecture 200 may connect one NID to another NID (e.g., as shown in FIG. 1, and also in FIG. 2 using the VPN gateways) that is geographically separate from the first NID (e.g., to form the inner VPN 202 or outer VPN 204), and may encrypt traffic at the link layer, creating the external encryption domain underlayment. The architecture 200 may connect (e.g., in serial), a second network interface device, using a separate cryptographic library than the first, to the underlayment network interface devices, creating the internal encryption domain overlay. These steps may be repeated to create a double encryption circuit when connecting endpoints at a planetary scale. In this manner, the NIDs (e.g., VPN gateways/switches) may be scalable to add other layers, each using another encryption (e.g., more encryption layers).

In one or more embodiments, the multi-layer encryption using MACsec may secure link layer discovery protocol (LLDP) traffic, link aggregation protocol (LACP) traffic, DHCP traffic, and ARP traffic, along with traffic using other protocols.

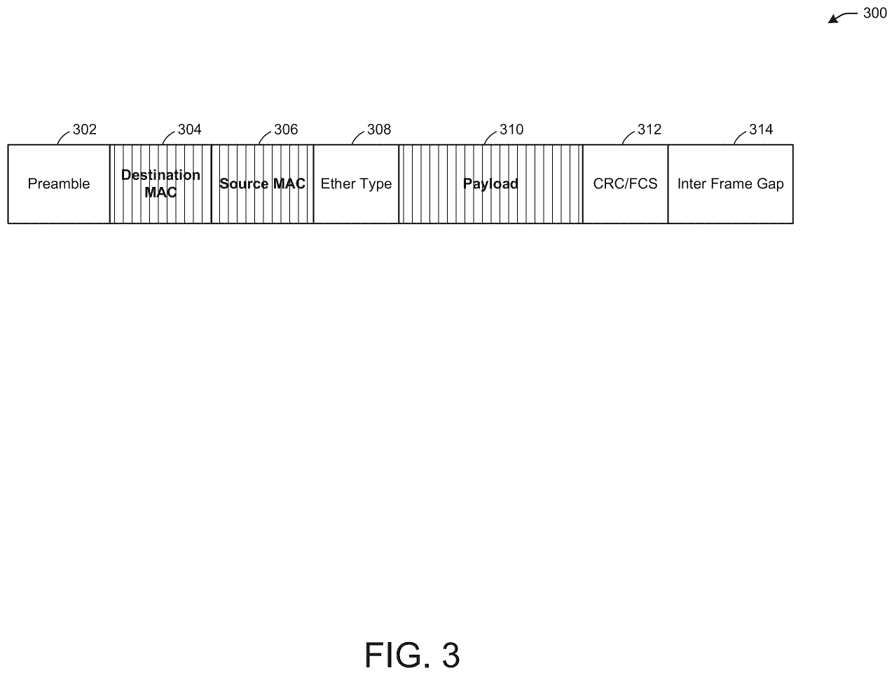

FIG. 3 illustrates an exemplary frame 300 encrypted using multi-layer encryption in accordance with one embodiment.

Referring to FIG. 2, the frame 300 may include multiple fields, such as a preamble 302, a destination MAC address 304, a source MAC address 306, an Ether Type field 308, a payload 310, a cyclic redundancy check/frame check sequence (CRC/FCS) field 312, and an inter frame gap 314. Layer-2 encryption may include encrypting the destination MAC 304, the source MAC 306, and the payload 310.

In one or more embodiments, the encryption technique used to encrypt the frame 300 may include a link layer (e.g., MACsec protocol) encryption. For example, the encryption may use GCM-AES-128, and may provide a secure key exchange between NIDs. The encryption may occur multiple times. For example, data (e.g., such as the frame 300) may be encrypted once, and then a second time, and even a third time, and so one, resulting in multi-layer encryption. In this manner, the frame 300 may represent traffic that is encrypted using multi-layer encryption by the systems of FIG. 1 and FIG. 2.

In one or more embodiments, when the encryption of the frame 300 uses MACsec, the security mode may include static connectivity association key (CAK) mode, static secure association key (SAK) mode, dynamic SAK mode, or another security mode. MACsec supports 128 and 256-bit cipher suites, a MACsec key agreement (MKA), and a single connectivity association (CA) per any physical port of a physical interface.

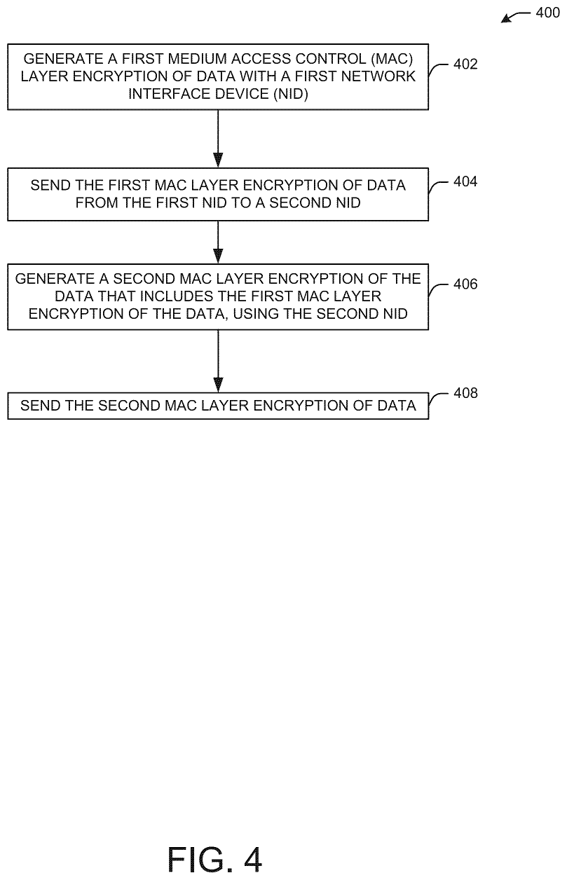

FIG. 4 is a flowchart illustrating a process for multi-layer encryption in accordance with one embodiment.

At block 402, a first NID (e.g., the NID 106 or the NID 108 of FIG. 1, the VPN gateway 214 or the VPN gateway 216 of FIG. 2) may generate a first MAC layer encryption (e.g., using MACsec or another layer-2 encryption protocol). For example, the encryption may include one or more fields of a packet, such as in FIG. 3.

At block 404, the first NID may send the encrypted data to a second NID (e.g., the NID 112 or the NID 114 of FIG. 1, the VPN gateway 210 or the VPN gateway 212 of FIG. 2).

At block 406, the second NID may generate a second MAC layer encryption by encrypting the first MAC layer encryption again (e.g., generating a multi-layer encryption). The encryption may use MACsec or another layer-2 encryption protocol (e.g., the same or a different protocol as the first MAC encryption).

At block 408, the second NID may send the second MAC layer encryption of data. In this manner, the data may be encrypted at least twice at the link layer. The data may include Ethernet data.

It is understood that the above descriptions are for purposes of illustration and are not meant to be limiting.

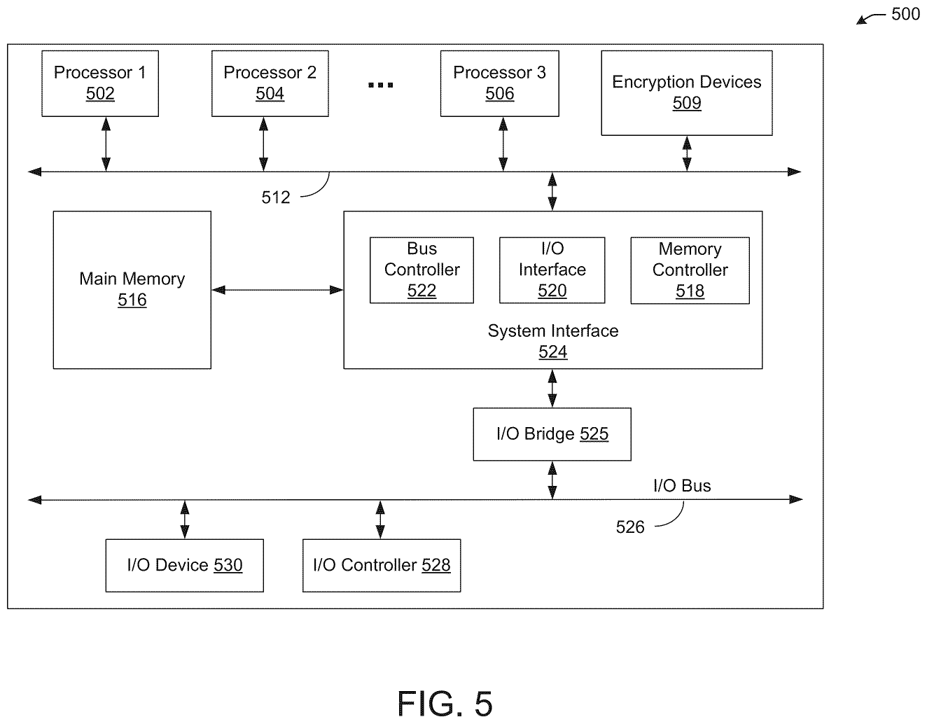

FIG. 5 is a block diagram illustrating an example of a computing device or computer system 500 which may be used in implementing the embodiments of the components of the network disclosed above. For example, the computing system 500 of FIG. 5 may represent at least a portion of the carrier network environment 100 shown in FIG. 1 and/or the architecture 200 of FIG. 2, and discussed above. The computer system (system) includes one or more processors 502-506 and one or more encryption devices 509 (e.g., representing at least a portion of the carrier network environment 100 shown in FIG. 1 and/or the architecture 200 of FIG. 2, capable of performing any operations described with respect to FIGS. 1-4). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for a carrier network to perform multiple layers of data encryption, the method comprising:
generating, by a first network interface device of a carrier network, a first medium access control (MAC) layer encryption of data;
sending, by the first network interface device to a second network interface device of the carrier network, the first MAC layer encryption of data;
generating, by the second network interface device of a carrier network, a second MAC layer encryption of data comprising the first MAC layer encryption of data; and
sending, by the second network interface device, the second MAC layer encryption of data.

2. The method of claim 1, wherein the first network interface device is a first switch device, and wherein the second network interface device is a second switch device.

3. The method of claim 1, wherein the first MAC layer encryption of data and the second MAC layer encryption of data use a MAC security (MACsec) protocol.

4. The method of claim 1, wherein the data are Ethernet data.

5. The method of claim 1, wherein a first virtual private network (VPN) comprises the first network interface device and the second network interface device.

6. The method of claim 5, wherein the second MAC layer encryption of data are sent to a first gateway device of the first VPN.

7. The method of claim 6, further comprising:
decrypting, by the first gateway device, the second MAC layer encryption of data,
wherein the first MAC layer encryption of data remains encrypted at the first gateway device.

8. The method of claim 7, further comprising:
sending, by the first gateway device, the decrypted MAC layer encryption of data to a second gateway device of a second VPN of the carrier network; and
decrypting, by the second gateway device, the first MAC layer encryption of data.

9. A system for a carrier network to perform multiple layers of data encryption, the system comprising at least one processor coupled to memory, the at least one processor configured to:
generate, by a first network interface device of a carrier network, a first medium access control (MAC) layer encryption of data;
send, by the first network interface device to a second network interface device of the carrier network, the first MAC layer encryption of data;
generate, by the second network interface device of a carrier network, a second MAC layer encryption of data comprising the first MAC layer encryption of data; and
send, by the second network interface device, the second MAC layer encryption of data.

10. The system of claim 9, wherein the first network interface device is a first switch device, and wherein the second network interface device is a second switch device.

11. The system of claim 9, wherein the first MAC layer encryption of data and the second MAC layer encryption of data use a MAC security (MACsec) protocol.

12. The system of claim 9, wherein a first virtual private network (VPN) comprises the first network interface device and the second network interface device.

13. The system of claim 12, wherein the second MAC layer encryption of data are sent to a first gateway device of the first VPN.

14. The system of claim 13, wherein the at least one processor is further configured to:
decrypt, by the first gateway device, the second MAC layer encryption of data,
wherein the first MAC layer encryption of data remains encrypted at the first gateway device.

15. The system of claim 14, wherein the at least one processor is further configured to:
send, by the first gateway device, the decrypted MAC layer encryption of data to a second gateway device of a second VPN of the carrier network; and
decrypting, by the second gateway device, the first MAC layer encryption of data.

16. A device for a carrier network to perform multiple layers of data encryption, the device comprising at least one processor coupled to memory, the at least one processor configured to:
generate, by a first network interface device of a carrier network, a first medium access control (MAC) layer encryption of data;
send, by the first network interface device to a second network interface device of the carrier network, the first MAC layer encryption of data;
generate, by the second network interface device of a carrier network, a second MAC layer encryption of data comprising the first MAC layer encryption of data; and
send, by the second network interface device, the second MAC layer encryption of data.

17. The device of claim 16, wherein the first network interface device is a first switch device, and wherein the second network interface device is a second switch device.

18. The device of claim 16, wherein the first MAC layer encryption of data and the second MAC layer encryption of data use a MAC security (MACsec) protocol.

19. The device of claim 16, wherein a first virtual private network (VPN) comprises the first network interface device and the second network interface device.

20. The device of claim 16, wherein a first virtual private network (VPN) comprises the first network interface device and the second network interface device.
